(19) United States
(12) Patent Application Publication
(10) Pub. No.: US 2014/0278526 A1
(43) Pub. Date: Sep. 18, 2014

(54) SYSTEMS AND METHODS FOR COMMUNICATING MEDICAL INFORMATION

(71) Applicant: HAPPYDOCS LLC, Manhattan Beach, CA (US)

(72) Inventors: Bhavik V. Thakkar, Marina Del Rey, CA (US); Kiran Rao, Marina Del Rey, CA (US)

(73) Assignee: HAPPYDOCS LLC, Manhattan Beach, CA (US)

(21) Appl. No.: 13/802,269

(22) Filed: Mar. 13, 2013

(51) Int. Cl. G06F 19/00

(52) U.S. Cl. CPC G06F 19/322
USPC 705/3

(57) ABSTRACT

A method of delivering a message containing medical information regarding a patient via a communications system is shown. The communications system is configured to receive the medical information from a first party and transmit medical information to a second party in a secured manner. The method includes receiving an audio message and a message recipient identity and storing the audio message. The method further includes transmitting the audio message for transcription and receiving a transcribed message data file from the transcription service. The method includes storing the transcribed message data file and analyzing the transcribed message data file to identify a patient identifier. The method includes formatting a notification that includes at least a portion of the transcribed message data file and the patient identifier. The method includes sending the notification to the message recipient.

### BACKGROUND OF THE INVENTION

After a hospital visit, a variety of patient's health information (“PHI”) needs to be communicated from the hospital setting (e.g., physicians, emergency department, attending, consultants, nurses, and other ancillary staff members, etc.) to other parties during a change in level of care and/or to a different form of a hospital setting (e.g., to a skilled nursing facility, a subacute rehabilitation facility, a long term acute care facility, etc.). The other parties may include outpatient physicians, nurses, case managers, and ancillary staff members within any integrated health delivery system (e.g., independent practice associations, health maintenance organizations, insurance companies, medical health plans, accountable care organizations, etc.). If the other party is an organization, the PHI may need to be distributed to associated team members, including physicians, nurses, case managers, and ancillary staff members. Efficient communication between these parties is essential for proper continuity of care after the patient's discharge from the hospital setting. Traditionally, medical information is communicated from the hospital to the third party via telephone. However, direct person-to-person telephone communication is often difficult because of unpredictable and different schedules of message senders and message recipients. If the hospital's initial attempts to communicate medical information regarding the patient's treatment are unsuccessful, inefficiencies and delays in the communication of PHI may arise. The resulting inefficiencies and delays may result in the decompensation of a patients' health status as a result of treatment delays, thereby directly causing an increase in readmissions to the hospital and an increase in overall treatment costs.

### SUMMARY OF THE INVENTION

One exemplary embodiment relates to a method of delivering a message on a communications system including a processor and a memory. The communications system is configured to receive and transmit medical information. The method includes receiving an audio message data file through a network interface of the system, wherein the audio message data file includes medical information about a patient. The method further includes receiving a message recipient identity through the transceiver of the system. The method includes storing the audio message data file and the message recipient identity in the memory. The method further includes transmitting the audio message data file for transcription through the transceiver of the system. The method includes receiving a transcribed message data file corresponding to the audio message data file from the transcription service through the transceiver of the system. The method further includes storing the transcribed message data file in the memory. The method includes analyzing the transcribed message data file to identify a patient identifier of the patient. The method further includes formatting a first notification, wherein the first notification includes at least a portion of the transcribed message data file and the last name of the patient. The method includes sending the first notification to the message recipient through the transceiver.

Another exemplary embodiment relates to a method of delivering a message on a communications system including a processor and a memory, the communications system is configured to receive and transmit medical information. The method includes receiving user log in information from a user through a network interface of the communications system. The method further includes recording a message from the user. The method includes storing the message in the memory. The method further includes transmitting an audio portion of the message for transcription through the network interface of the system. The method includes receiving a transcribed message data file corresponding to the audio portion from the transcription service through the network interface of the system. The method further includes storing the transcribed message data file in the memory. The method includes receiving an attachment to the message from the user through the network interface. The method further includes analyzing the transcribed message data file to identify a patient identifier of the patient.

Yet another exemplary embodiment relates to non transitory computer readable media with computer-executable instructions embodied thereon that, when executed by a computing system, perform a method of delivering a message having medical information about a patient. The computer-readable media includes instructions for receiving an audio message data file through a network interface of the system, wherein the audio message data file includes medical information about the patient. The computer-readable media further includes instructions for receiving a message recipient identity through the transceiver of the system. The computer-readable media includes instructions for storing the audio message data file and the message recipient identity in the memory. The computer-readable media includes instructions for transmitting the audio message data file for transcription through the transceiver of the system. The computer-readable media includes instructions for receiving a transcribed message data file corresponding to the audio message data file through the transceiver of the system. The computer-readable media further includes instructions for storing the transcribed message data file in the memory. The computer-readable media includes instructions for analyzing the transcribed message data file to identify a last name of the patient. The computer-readable media further includes instructions for formatting a first notification, wherein the first notification includes at least a portion of the transcribed message data file an identifier of the patient. The computer-readable media includes instructions for sending the first notification to the message recipient through the transceiver.

The invention is capable of other embodiments and of being carried out in various ways. Alternative exemplary embodiments relate to other features and combinations of features as may be generally recited in the claims.

The foregoing is a summary and thus, by necessity, contains simplifications, generalizations, and omissions of detail. Consequently, those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

FIG. 1 is an overview of a system for facilitating communication of medical information between parties according to an exemplary embodiment.

FIG. 2 is a block diagram of a system server according to an exemplary embodiment.

FIG. 3 is a block diagram of programming modules and databases stored on the system server according to an exemplary embodiment.

FIG. 4 is a flow diagram of a method of facilitating communication of a recorded message containing medical information from a sending party to a recipient according to an exemplary embodiment.

FIG. 5 is a flow diagram of a method of receiving an audio message from a user by telephone at a voicemail system according to an exemplary embodiment.

FIG. 6 is a flow diagram of a method of recording an audio message through a system interface according to an exemplary embodiment.

FIG. 7 is a flow diagram of a method of accessing the full contents of a message received via a communication system according to an exemplary embodiment.

### DETAILED DESCRIPTION OF EXEMPLARY EMBODIMENTS

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting. Unless otherwise specified, “a” or “an” means “one or more.”

Referring to FIG. 1, a system 100 for facilitating communication of medical information between parties is shown according to an exemplary embodiment. System 100 facilitates communication between sending party 101 and receiving party 102. Generally, sending party 101 is affiliated with a hospital based setting (e.g., physicians; emergency department, attending, consultants, nurses, other ancillary staff members, etc.) for inpatient treatment of a patient and receiving party 102 may be affiliated with a change in level of care to a different form of a hospital setting (e.g., skilled nursing facility, subacute rehabilitation facility, long term acute care facility, etc. and all of their associated team members including physicians, nurses, case managers, ancillary staff members). Receiving party 102 may be an outpatient physicians, a nurse, a case manager, an ancillary staff member within any integrated health delivery system (e.g., independent practice associations, health maintenance organizations, insurance companies, medical health plans, accountable care organization, etc.). Receiving party 102 requires information pertaining to the patient's health information (“PHI”) during their inpatient hospitalization. System 100 facilitates the delivery of medical messages from sending party 101 to receiving party 102 without a live person-to-person telephone call. The following paragraphs present a general overview of the operation of system 100. A more detailed description of the operation of system 100 follows.

Generally, system 100 is operable to receive a recorded message from sending party 101. The message includes information pertaining to a PHI. The message may include any of audio data, text data, video data, and/or image data and the message is stored on server 103. Sending party 101 can provide the message to server 103 in multiple ways. Sending party 101 may dial a system access number (e.g., a 1-800 number) with a telephone (e.g., telephone 104 or smartphone 105) and leave a voice message with a system voicemail service 106. Voicemail service 106 may be hosted on server 103 or may be a third party voicemail provider (e.g., Grasshopper®, Google Voice®, etc.). Sending party 101 leaves a voice message that includes pertinent PHI, along with information that identifies receiving party 102. The recorded audio message is then transmitted from voicemail service 106 to system server 103 through network 107 (e.g., the Internet, a private local area network, etc.). The message is stored at server 103. Alternatively, sending party 101 records a message via system software or through a system website with a personal computing device (e.g., smartphone 105, computer 108, a laptop, a tablet computer, etc.) or provides a previous recording from a dictation device via system software or through a system website. In either of these alternatives, the user may also include additional attachments to the recorded message (e.g., pictures, documents, videos, etc.). In such an alternative, the message is sent directly from the user's computing device to server 103 through network 107 after sending party 101 records it.

After being stored on server 103, the recorded audio message is sent to transcription service 109, where the recorded audio is converted to text. Transcription service 109 is a third-party service provider. The message is sent from either voicemail service 106 or system server 103 through network 107 to transcription service 109. Alternatively, transcription service 109 is hosted on server 103. Transcription service 109 is a Health Insurance Portability and Accountability Act (“HIPAA”) compliant medical transcription service, and after the transcription is complete, the transcribed message data is sent via network 107 back to server 103, where the transcribed message data is stored.

System 100 is then operable to initiate an alert to and to later send message contents to receiving party 102. System 100 formats an initial alert for transmission to receiving party 102. The initial alert may be transmitted via e-mail, SMS text message, MMS multimedia message, and/or via a system user-access application (e.g., as a notification to a system account accessible via a smartphone application, a tablet application, or an Internet browser). The initial alert includes at least a portion of the transcribed message text. The initial alert may include less than the full transcribed message data to help protect the privacy of the patient. Accordingly, system 100 may filter or scrub the transcribed message data during alert formatting. After receipt of the alert, receiving party 102 may access the entire contents of the original message from sending party 101 (e.g., the recorded audio, supplied video, supplied pictures, etc.) after logging into system 100 through an authentication process.

System 100 may be operable to facilitate a back and forth conversation between sending party 101 and receiving party 102. For example, if receiving party 102 has a follow-up question for sending party 101, receiving party 102 may initiate a return message to sending party 101 through the same procedure followed by sending party 101 in delivering the original message. Alternatively, receiving party 102 may initiate a reply message through system software or the system's website. The reply message may be an audio message, a video message, or a text message. The follow-up question may include attachments, such as pictures, documents, and videos. System 100 may maintain a threaded conversation between the two parties that is visible when either party logs into a system application.

Still further, system 100 may be operable to maintain searchable patient records. Accordingly, when multiple messages are sent via system 100 that pertain to a single patient, the messages may be indexed and stored in a searchable manner. A user of system 100 can search for a patient by various identifiable measures including (e.g., last name, first name, middle name, date of birth, social security number, medical record number, date of message, any component of the PHI provided, or a combination thereof). Additionally, when a patient is displayed on a user interface of a system application, system 100 may automatically format the name as a clickable link. If the link is clicked on by the user, system 100 automatically performs a search for additional records of the patient and displays them to the user. System 100 may filter the search results such that it only presents the user results that the user has permission to access (i.e., there may be records from another doctor that are privileged and cannot be accessed by the user).

Further details and characteristics of the operation of system 100 are discussed below with respect to FIG. 2 through FIG. 7.

Referring to FIG. 2, a block diagram of system server 103 is shown according to an exemplary embodiment. Server 103 includes processing circuit 201, which controls the operation of server 103, and accordingly controls the operation of much of system 100. Processing circuit 201 includes processor 202 and memory 203. Server 103 includes at least one mass storage unit 204. Various system databases and system programming modules may be stored in mass storage unit 204 and/or memory 203. Server 103 includes network interface 205, which enables data transfer and communication to and from server 103 via network 107. Network interface 205 may be a wired network transceiver (e.g., Ethernet) or a wireless network transceiver operating under a standard wireless networking protocol (e.g., 802.11, CDMA, GSM, LTE, WiMax, Bluetooth®, 802.15, etc.).

Referring to FIG. 3, a block diagram of programming modules and databases stored on server 103 is shown according to an exemplary embodiment. Mass storage unit 204 stores message database 301 and user database 302. Message database 301 includes original message content received from sending party 101 (e.g., audio message data, video message data, image data, text data, etc.) and transcribed message data. Individual messages may be indexed by any of patient name, patient identifier, sending party, receiving party, date, importance level, or any combination thereof. The messages may be stored in according to a hierarchical model, a network model, an inverted file model, a relational model, an entity-relationship model, an object model, or any other database data storage model. User database 302 includes data relating to each registered user and entity, including user identities (e.g., name, social security number, driver's license number, medical license number, other identifying account numbers, etc.), contact information (e.g., mail address, work telephone number, mobile telephone number, e-mail address, etc.), titles, employer information, insurance information, religious beliefs, criminal history, notification preferences, permission levels, usernames, passwords, associated users having access permissions (e.g., specified employees of an organization or company that is a registered user of system 100), and any other necessary information. User database 302 may also include information relating to user generated content (e.g., uploaded content such as photos, videos, documents, comments, etc.) and user relationships (e.g., a first user stores a second user as frequent contact in an address book or as a friend).

Mass storage unit 204 stores various programming modules. The programming modules are drawn as being stored on mass storage unit 204, however, the programming modules may alternatively be stored in memory 203. The programming modules include all instructions necessary to operate server 103. Programming modules are executed by processor 202. Such modules are shown to include: transcription service communication module 303, voicemail service communication module 304, user authentication module 305, message analysis module 306, alert/message module 307, user interface module 308, and user communication module 309. Multiple modules may be used together to perform complex functions.

Referring to FIG. 4, a method 400 of facilitating communication of a recorded message containing medical information from a sending party to a recipient via a communication system (e.g., system 100) is shown according to an exemplary embodiment. The sending party may be an inpatient physicians, emergency department doctors, an attending doctors, consulting doctors, nurses, ancillary staff members, or another medical professional associated with the medical care of a patient. The message recipient may require access to the information conveyed in the message to perform further services related to the medical treatment of a patient examined by the sending party. The message recipient may be an outpatient physician, a nurse, a case manager, ancillary staff members within an integrated health delivery system (e.g., independent practice associations, health maintenance organizations, insurance companies, medical health plans, accountable care organizations, etc.).

Method 400 begins when the system receives message data from a sending party (step 401). The message data includes an audio message recorded from the sender. The audio message may be part of a video recording, and the message data may be supplemented with image data, video data, and/or text data. The message data is received through a network interface of a system server (e.g., network interface 205) directly from the sending party (e.g., data transmitted from smartphone 105 through network 107 to server 103). Alternatively, the message data is received from a voicemail service (e.g., voicemail service 106). The message data generally includes information relating to the identity of the sending party, the identity of a designated recipient of the message, and pertinent PHI. The medical information surrounding the treatment of the specified patient may include any information surrounding the specified patient. For example, the information may include a brief description of an ailment or a detailed description of various medical procedures performed and suggested outpatient treatment strategy coupled with video and/or image data. The message may include additional information such as a priority level (e.g., urgent if the patient is in critical need of additional medical attention), an indicated time for reply, additional sending party contact information, or any other information the sending party wishes to include in the message. The recording of the message data is further described below with respect to FIG. 5.

After receiving the message data, the system sends any received audio data to a transcription service (step 402). The audio message data is sent through the system's network interface over a network to the transcription service (e.g., transcription service 109). Alternatively, the system includes an integrated transcription service, and the transcription is performed internally by the system. If the audio data is included in a video file, the system first separates the audio data from the video data such that just audio data is sent to the transcription service. The transcription service is a HIPAA compliant transcription service. After the transcription service finishes transcribing the audio portion of the message, the transcription service sends the transcribed message back to the system, and the message is received by the system through the system's network interface (step 403).

The system then analyzes the message data (step 404). During the analysis, the system identifies portions of the transcribed text that correspond with blocks of patient health information (e.g., specific fields of information such as patient name, patient date of birth, doctor name, etc.) that will be utilized in the creation of an outgoing alert. The outgoing alert will ultimately be sent to the message's recipient. The blocks of information include, but are not limited to, the sending party's name, whether this is regarding a patient's admission or discharge, the patient's first and last names, the patient's date of birth, the principal problem (e.g., diagnosis requiring admittance to the hospital), any action taken at the hospital, any relevant lab results (e.g., results from a blood test), any relevant imaging results (e.g., results from an ultrasound, results from an X-Ray, etc.), any relevant medication changes, any relevant recommended discharge plan, and any other designated field to be populated. The system is configured to automatically detect the above-noted aspects from the message by performing a text analysis of the transcribed message. To assist with automatically detecting the above-described information, the sending party may be instructed to leave the initial voice message with the voicemail service (e.g., voicemail service 106) in a designated cadence. For example, when the sending party calls into the voicemail service, the voicemail service may instruct the sending party to follow a script:

Voicemail Service: What is your name? Please spell your last name.

Sending Party: Dr. John Smith. S-M-I-T-H.

Voicemail Service: Who is the patient? Please spell the patient's last name.

Sending Party: Dave Craig. C-R-A-I-G.

Voicemail Service: What is the patient's date of birth?

Sending Party: Mar. 5, 1985.

Voicemail Service: Is this regarding the patient's admission to or discharge from the hospital?

Sending Party: Admission.

Voicemail Service: What was the principal reason for the patient's admittance?

Sending Party: The patient was experiencing chest pains.

The transcription service or the voicemail service may separate each individual response into a separate file. Alternatively, the user may be instructed to leave the voice message in the cadence based on a display (e.g., a display of the user's smartphone) that instructs the proper order to leave information, and the system recognizes the message sequence and matches portions of the transcribed message to designated matching blocks of information.

Based on the information gathered during analysis of the transcribed message, the system formats an alert to the designated recipient (step 405). The alert may be an e-mail message to be delivered to the recipient. The formatted e-mail alert includes at least the sending party's name (e.g., Dr. John Smith), the patient's last name, and a brief description of the contents of the message (e.g., whether this is regarding a patient's status such as admission or discharge, the patient's date of birth, the principal problem or reason for admittance to the hospital, action taken at the hospital, relevant lab results, relevant imaging results, a recommended discharge plan, etc.). The formatted e-mail may exclude portions of the full message to protect the patient's privacy. For example, the formatted e-mail message may only include the patient's first initial and last name, not the patient's full name. As discussed below with respect to steps 409-413, the recipient of the message can later access the full contents of the message after an authentication process. The formatted e-mail further includes a link that directs the recipient to the entire contents of the sending party's original message, including any non-audio. The link may link to a system website or to a system application. The system may also format other forms of alerts to be sent to the recipient (e.g., an SMS text message, an MMS multimedia message, a system application push notification, etc.). It should be understood that each channel of alert has different restrictions (e.g., SMS text messages are often limited to 160 characters). Accordingly, each type of alert message may be formatted differently. For example, a formatted SMS alert may only include the sending party's name, the patient's last name, the patient's first initial, the principal problem, and a link to the full contents of the message. Each alert directs the recipient to a location to view the entire contents of the message.

After the alerts are formatted, the system then initiates the sending of the alerts to the designated recipient through the network interface of the system (step 406). The system sends a single alert over a single channel (e.g., the system sends a single e-mail alert to the recipient). Alternatively, the system sends redundant alerts over multiple alert channels (e.g., the system sends both an e-mail alert and an SMS alert to the recipient). The alert may be sent directly by the system through an internal messaging system or indirectly by the system through delivery to a third-party messaging service (e.g., an e-mail server, an SMS server, etc.).

After sending the alert to the recipient, the system waits for a confirmation of receipt of the alert from the recipient (step 407). Upon viewing of the alert, a confirmation may be automatically transmitted from the recipient to the system through the network interface of the system. Alternatively, the recipient may be required to initiate the sending of a confirmation signal to the system. The system waits for a reply for a designated period of time (e.g., 10 minutes, 30 minutes, one hour, 6 hours, 24 hours, etc.). The specific period of time may be a standard period of time for every message. Alternatively, the period of time allowed for confirmation may be specified by the sending party. In yet another alternative, the system may have specified periods of time for confirmation that varies depending on the priority level of the message (e.g., 10 minutes for an urgent message, 2 hours for a low-priority message, etc.). Throughout the step 407, the system determines if it received a confirmation from the recipient (step 408). If no confirmation is received by the expiration of the designated time period, the system returns to step 406 and resends the alert to the designated recipient. The system may perpetually repeat sending notifications to the recipient until a confirmation is received. Alternatively, the system may be programmed to stop resending notifications after a certain number of attempts or after the expiration of a period of time. Further, the system may initiate a notification to the sending party to inform the sending party of the lack of a confirmation of receipt on behalf of the recipient.

The system is configured to track message recipient responsiveness. The system tracks this metric in multiple ways, including average response time and average number of alerts needed to receive a response for a message. Accordingly, the system calculates a recipient response time (e.g., the time between when the alert was first sent to the recipient and when the confirmation was received) and calculates the number of alerts sent before the recipient first responded. Both of these numbers are stored and associated with the recipient in the user account database of the system (e.g., user database 302). The system uses these figures to calculate both an average response time and an average number of alerts needed for each registered recipient to respond to an alert or to confirm receipt of the alert. The recipient responsiveness metric may be represented as an average response time, an average number of alerts needed to receive a response, a ranking as compared to other recipients (either as compared to the overall number of registered recipients or as compared to the number of registered recipients practicing in the same field), or as a percentile ranking. After calculating the recipient responsiveness metric, the system stores the recipient responsiveness in the user account database. Any recipient's responsiveness may be communicated to the sending party prior to selecting a recipient. For example, if the sending party wishes to send a message to an outpatient orthopedic surgeon, the system may present multiple orthopedic surgeon recipient options to the sending party for the sending party to select among. In addition to presenting the sending party each individual orthopedic surgeon's contact information, the system can also present each surgeon's responsiveness. Accordingly, the sending party can choose to send the message to a recipient having an acceptable level of responsiveness and avoid sending the message to a recipient having an unacceptable level of responsiveness. Thus, the tracking and advertising of recipient responsiveness incentivizes prompt and compliant recipient responses as a highly rated message recipient may receive more business inquiries based on his high system rating.

If a confirmation is received, the system waits to receive recipient authentication (step 409). The authentication information is provided when the recipient wishes to access the entire contents of the sending party's message. As indicated above, the alert is formatted in such a way that the entire transcription of the message is not available. Further, the alert does not include any additional message information (e.g., accompanying pictures, video data, etc.). In order to access the full contents of the message sent by the sending party, the recipient must verify his or her identity within the system. Accordingly, the recipient provides authentication information (as discussed below with respect to FIG. 7), which is received through the network interface at the system (step 410). The authentication information may relate to a username and password, a PIN (e.g., a numeric password capable of being provided via a touchtone telephone), biometric data, or another form of user verification. The system determines if the provided authentication information is correct (step 411). The system does so by cross-referencing the provided authentication information with stored authentication information received during a registration of the recipient with the system (e.g., a username and password stored in user database 302).

If the provided authentication information is not correct, the system sends an indication to the recipient that the authentication failed and instructs the recipient to provide authentication information again (step 412). The system then returns to step 409, and the system waits for the recipient to provide authentication information. If the authentication information is correct, the system makes the entire message contents available to the recipient (step 413). The message contents may be viewed as embedded material on a system application or on a system website. Alternatively, the recipient may be directed to a download link where the recipient can download the contents to a computing device. The full contents of the message are sent to the recipient through the system's network interface. After the full contents of the message are successfully transmitted to the recipient, method 400 ends.

Referring to FIG. 5, a method 500 of recording an audio message from a user by telephone at a voicemail system (e.g., voicemail service 106) for later delivery to a recipient via a communication system (e.g., system 100) is shown according to an exemplary embodiment. The message recorded with method 500 may later be delivered to a communication system (e.g., system server 103) and/or a transcription service (e.g., transcription service 109). Method 500 begins when a telephone connection is established between a user and the voicemail system (step 501). The connection is made when the user dials a system access number. The access number may be a toll-free telephone number or a standard telephone number.

After the connection is established the system receives the user identification number and PIN (step 502). After establishing the connection between the user and the voicemail system, the voicemail system greets the user and instructs the user to provide the user's identification number and access PIN (e.g., a numeric password capable of being provided via a touchtone telephone). The user must be registered with the system in order to record a message and instruct delivery to a recipient. Upon registration, the user receives a user ID number and a user PIN. Accordingly, the user provides the ID number and PIN over the phone, and the information is received and verified by the voicemail system. The user may provide the ID number and PIN by pressing buttons on the phone (e.g., by entering a series of numbers via the phone's keypad) or by orally providing the series of numbers. If the provided user ID number and PIN do not match a user ID and PIN combination stored in a user account database (e.g., user database 302), the voicemail system instructs the user to re-enter his or her user ID and PIN. In some arrangements, the voicemail system is a separate system from the message delivery system and does not include the user account database. In such an arrangement, the voicemail system may communicate with the message delivery system via a network (e.g., network 107, the Internet, etc.) to confirm a matching a user ID and PIN combination (e.g., by having the message delivery system transmit a confirmation or rejection of the provided user ID and PIN combination). Upon entry of a provided user ID and PIN that matches a user ID and PIN stored in the user account database, the voicemail system greets the user and indicates that the user has gained access to the message delivery system.

After providing the user access to the message delivery system, the system receives the recipient's identification number (step 503). The voicemail system instructs the user to provide the recipient's ID number, and the user enters the recipient's ID number in the same manner the user entered his own user ID number. In some situations, the user may not know the recipients system ID number. In this case, the user may send a command to the voicemail system (e.g., by pressing a designated key or speaking a word) in order to gain access to a recipient directory. Upon receipt of the command, the voicemail system instructs the user to enter the recipient's last name, a portion of the recipient's last name (e.g., the first three letters), or a company/organization name. The user then provides the letters by speaking the letters or by interacting with the corresponding keys of the phone. Upon receipt of the letters, the voicemail server will search the user account database and audibly transmit a matched name, a matched company, a matched organization, or a listing of matched names for confirmation or selection by the user.

Once a recipient is selected, the system records the user's message (step 504). The voicemail system communicates an instruction to the user containing a standard format of the message. For example, the voicemail system may play an audio prompt instructing the user to “clearly speak your name and various pertinent patient health information in the following order: the patient's full name, the patient's date of birth, whether this is regarding the patient's admission or discharge, the principal problem, any information about treatment performed, and recommended discharge plan, etc.” Alternatively, the user may be informed of the proper message format prior to dialing the voicemail system or during the call to the voicemail system by a system user interface (e.g., as displayed on the user's smartphone or computer screen) or by a prior instruction from the system. As discussed above with respect to method 400, the message communication system is configured to automatically detect the above-noted aspects from the message by performing a text analysis of the transcribed message. Alternatively, as noted above, the voicemail system may provide separated prompts that take the form of a conversation between the voicemail system and the user to record the message in an organized manner (i.e., the voicemail system asks a series of questions to which the user responds as discussed above with respect to step 404 of method 400).

After the user is done recording the message, the voicemail system receives an indication that the message is complete from the user (step 505). The user may indicate the completion of the message by pressing a button on the phone's keypad (e.g., the “*” button). Upon receipt of the user indication of the message being completed, the voicemail system indicates that it will playback the message for verification, and the system does so (step 506). During playback, the user determines if the message is acceptable as recorded (step 507). If the message is not acceptable, the user indicates so by pressing a designated button on the phone's keypad, and method 500 returns to step 504 for re-recording of the message. If the message is acceptable, the user sends an indication that the message is acceptable by pressing a designated button on the phone's keypad (step 508). Upon receipt of the acceptability indication, the message is stored in memory of the voicemail system for later delivery to the message communication system, later analysis, later transcription, and later delivery to the recipient. After the message is indicated as acceptable, method 500 ends. Further, at any point prior to determining the confirmation of sending the message, the user can end the process by hanging up the phone and disconnecting from the voicemail server. If the user hangs up prior to recording a message or indicating a recorded message as acceptable, no message is sent to a recipient.

Referring to FIG. 6, a method 600 of recording an audio message through a system interface (e.g., a smartphone application, a tablet computer application, a website, system software, etc.) for later delivery to a recipient via a communication system (e.g., system 100) is shown according to an exemplary embodiment. The recorded message may later be delivered to a transcription service (e.g., transcription service 109). Method 600 begins when the system receives a user log on request to access the user's system account via a user interface on a system application (step 601). The log on request is received through a network interface of the system. The application may be system software loaded onto the user's computing device (e.g., a smartphone application) or a website accessed by the user. The user must be registered with the system in order to record a message and instruct delivery to a recipient. Upon registration, the user receives a username and a password. Accordingly, the user provides the username and password by typing into the designated boxes. The user then clicks a sign in or log in button and sends the entered username and password to the system. The system receives the log in information and verifies that the username and password match a username and password in a system user account database (e.g., user database 302). If the provided username and password do not match a username and password combination stored in the user account database, the system instructs the user to re-enter his or her log in credentials by updating the user interface of the system application (e.g., by indicating that the log in attempt was unsuccessful). Upon a provided username and password that matches a username and password in the user account database, the system updates the user interface to indicate that the user has been granted access to the system.

The system receives a user request to create a new incident report (step 602). The user initiates the request through interaction with the user interface of the system application. An incident report includes at least an audio message that is to be delivered to a recipient. Upon a successful log in, the system may present the user multiple options via the user interface. For example, in addition to creating a new incident report, there may be options to view alerts, view messages, check the status of sent messages, lookup patient information, and lookup recipient doctor information. The system then receives a recipient identification from the user (step 603). Upon the user's indication that a new incident report is to be created, the system updates the user interface and instructs the user to select a recipient of the incident report. The user can select the recipient by entering the recipient's system username. The user's selection may correspond to a selection from an address book or list of contacts that the user has associated with his system account. If the user does not know the recipient's username, the user can lookup the recipient's username by searching for the recipient by name, location, company affiliation, medical specialty, or any combination thereof.

After designating the recipient to the message, the system records the user's message (step 604), and the recording may be an audio recording or a video and audio recording. The system updates the user interface to provide the user instructions as to a standard format of the message. For example, the system may instruct the user to “clearly speak your name, the patient's full name, the patient's date of birth, whether this is regarding the patient's admission or discharge, the principal problem, any information about treatment performed, and recommended discharge plan.” As discussed above with respect to method 400, the message communication system is configured to automatically detect the above-noted aspects from the message by performing a text analysis of the transcribed message. Alternatively, as noted above, the system may provide a series of separated question prompts such that the message is recorded in the form of a conversation between the system and the user to record the message (i.e., the system asks a series of questions either audibly or displayed through the user interface to which the user responds as discussed above with respect to step 404 of method 400). The recording is stored in a memory of the system.

After recording the message, the system presents the message to the user for review (e.g., the user can select to play back the recorded message) and the user determines if the message is acceptable (step 605). If the message is not acceptable, the user indicates so by interacting with the user interface (e.g., selecting a “redo” or a “X” button of the user interface). Upon receipt of the user indication, the system returns to step 604 for re-recording of the message. If the message is acceptable, the user indicates so by interacting with the user interface (e.g., selecting an “accept” or “✓” button of the user interface). Upon receipt of the acceptability indication, the system stores the message in memory of the system for later transcription and delivery to the recipient.

After the message is indicated as acceptable, the system updates the user interface to present the user the option of attaching additional files and of providing additional information (step 606). The user has the ability to attach image files (e.g., pictures of a wound, pictures of X-rays, pictures of ultrasounds, etc.), video files (e.g., videos of a surgery, videos of a test, etc.), and document files (e.g., a patient's medical history report, an article about a medical treatment, etc.). The user can select already existing files on the user's computing device (e.g., in the memory of the user's smartphone, tablet, or computer), or the user can create a new file by capturing a video or an image with a camera of the user's computing device. After all attachments and additional information is received, the user indicates that the message is ready for transmission to the recipient (step 607), and method 600 ends.

Referring to FIG. 7, a method 700 of accessing the full contents of a message received via a communication system (e.g., system 100) is shown according to an exemplary embodiment. Method 700 begins when the system transmits an alert to a user indicating that a message is waiting, and the user receives the alert (step 701). The alert may be sent by the system to the user over multiple channels for redundant notification (e.g., an alert via more than one of the following channels: e-mail, SMS text message, application notifications, alerts inside the application or website, etc). Each alert may have a different format. However, each alert includes at least an indication that a message is waiting and a link to the full contents of the message. The alert does not include the full contents of the message. When the alert is opened, an automatic confirmation of receipt signal is sent from the user's computing device to the system. Alternatively, a confirmation of receipt signal is not sent until the user activates the link contained in the alert (as discussed below with respect to step 702). The confirmation is received by the system through a network interface of the system.

After receiving the alert, the system receives an indication from the user that the user wishes to access the full contents of the message (step 702). Typically, the user sends this indication by activating a link in the alert (e.g., by clicking a hyperlink). Activation of the link directs the user to a system interface (e.g., a system website, a system smartphone application, etc.). When the user activates the link, a request for the complete message contents is sent from the user's device (e.g., computer, smartphone, tablet) to the system. Receipt of the request from the user may serve as a confirmation of receipt of the original alert if one was not previously sent by the user. Additionally, in response to receiving the request, the system indicates to the user that the user must provide authentication information (e.g., by logging into the system with a username and password) prior to accessing the full contents of the message. Alternatively, the user may gain access to the entire contents of the message without clicking on a link in a received alert. In such an alternative arrangement, the user logs onto the user's account and accesses a message inbox to view the contents. If the user logs onto the account prior to accessing the message, the user does not need to provide additional authentication information and step 703 is skipped.

The system receives authentication information from the user (step 703). In order to receive alerts and access message contents, the user must be registered with the system. Upon registration, the user receives a username and a password. Accordingly, the user provides the username and password by typing into the designated boxes of the system's user interface. The user then clicks a sign in or log in button and sends the entered username and password to the system. The system receives the log in information and verifies that the username and password match a username and password in a system user account database (e.g., user database 302). If the provided username and password do not match a username and password combination stored in the user account database, the system instructs the user to re-enter his or her log in credentials by updating the user interface of the system application (e.g., by indicating that the log in attempt was unsuccessful).

Upon a successful authentication attempt, the system provides the user access to the message contents (step 704). The user can then view and/or download the entire contents of the message via the user interface of the system application. The system transmits the contents of the message to the user's computing device and displays the contents or links to the content files to the user through the system user interface. The contents of the message may be represented within the user interface by text, images, embedded video files, embedded audio files, and/or downloadable files. The user then reviews the contents of the message and determines if more information is needed from the sending party (step 705). If more information is needed, the user may initiate a reply message to the sending party of the message (e.g., the inpatient physician-sending party 101), which is sent by the system (step 706). The message may be a text message that is typed into the user interface. Alternatively, the message may be a recorded audio or video message, in which case the message is transmitted after its recording in the same manner as described above with respect to method 400. If a reply message is transmitted by the system, the system alerts the original sending party (the recipient of the reply message) to the message's presence. The original sending party then has the ability to respond to the reply message. The system may be operable to maintain a threaded conversation of messages between the original sending party and the original recipient. If no additional information is needed, method 700 ends after delivery of the full message contents is completed to the recipient.

Although the above systems and methods have been described as facilitating the communication of medical information between parties, it should be understood that the above systems and methods may be employed outside of the medical field. For example, the above systems and methods may be modified for use with emergency response communications, insurance claim communications, legal advice communications, or any other type of communication between two parties. Additionally, data transmission between the above described systems and components is facilitated over networks (e.g., network 107, the Internet, etc.) through network interfaces and/or transceivers of the individual components. Further, the portions of the above methods that are performed by computing systems (e.g., by system 100, by server 103, by transcription service 109, by voicemail service 106, etc.) may be programmed as computer-executable instructions embodied on non-transitory computer readable medium, such that when executed by a processor of a computer system having memory, the methods are performed.

It is important to note that the construction and arrangement of the elements of the systems and methods as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the enclosure may be constructed from any of a wide variety of materials that provide sufficient strength or durability, in any of a wide variety of colors, textures, and combinations. Additionally, in the subject description, the word “exemplary” is used to mean serving as an example, instance, or illustration. Any embodiment or design described herein as “exemplary” is not necessarily to be construed as preferred or advantageous over other embodiments or designs. Rather, use of the word “exemplary” is intended to present concepts in a concrete manner. Accordingly, all such modifications are intended to be included within the scope of the present inventions. The order or sequence of any process or method steps may be varied or re-sequenced according to alternative embodiments. Any means-plus-function clause is intended to cover the structures described herein as performing the recited function and not only structural equivalents but also equivalent structures. Other substitutions, modifications, changes, and omissions may be made in the design, operating conditions, and arrangement of the preferred and other exemplary embodiments without departing from scope of the present disclosure or from the spirit of the appended claims.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps, and decision step.

What is claimed is:

1. A method of delivering a message on a communications system including a processor and a memory, the communications system is configured to receive and transmit medical information, the method comprising:
receiving an audio message data file through a network interface of the system, wherein the audio message data file includes medical information about a patient;
receiving a message recipient identity through the transceiver of the system;
storing the audio message data file and the message recipient identity in the memory;
transmitting the audio message data file for transcription through the transceiver of the system;
receiving a transcribed message data file corresponding to the audio message data file through the transceiver of the system;
storing the transcribed message data file in the memory;
analyzing the transcribed message data file to identify a patient identifier for the patient;
formatting a first notification, wherein the first notification includes at least a portion of the transcribed message data file an identifier of the patient; and
sending the first notification to the message recipient through the transceiver.

2. The method of claim 1, further comprising receiving authentication information from the message recipient through the transceiver, wherein the authentication information relates to a username.

3. The method of claim 2, wherein the authentication information further includes a password.

4. The method of claim 2, further comprising providing the message recipient access to the audio message data file and the transcribed message data file.

5. The method of claim 1, wherein the first notification is sent via e-mail to the message recipient.

6. The method of claim 1, wherein the first notification is sent via SMS to the message recipient.

7. The method of claim 1, further comprising formatting a second notification, wherein the second notification includes at least a portion of the transcribed message data file and the last name of the patient, and sending the second notification to the message recipient through the transceiver; wherein the first notification is sent via e-mail and the second notification is sent via SMS.

8. The method of claim 1, further comprising waiting for a confirmation of receipt of the first notification from the message recipient.

9. The method of claim 8, further comprising resending the first notification to the message recipient if the confirmation of receipt is not received from the message recipient after the expiration of a designated period of time.

10. The method of claim 8, further comprising receiving the confirmation of receipt; calculating a response time; and calculating a recipient responsiveness metric based on the response time.

11. The method of claim 1, wherein the transcription is provided by a transcription service which is a Health Insurance Portability and Accountability Act compliant medical transcription service.

12. A method of delivering a message on a communications system including a processor and a memory configured to receive and transmit medical information, the method comprising:
receiving user log in information from a user through a network interface of the communications system;
recording a message from the user;
storing the message in the memory;
transmitting an audio portion of the message to a transcription service through the network interface of the system;
receiving a transcribed message data file corresponding to the audio portion from the transcription service through the network interface of the system;
storing the transcribed message data file in the memory;
receiving an attachment to the message from the user through the network interface; and
analyzing the transcribed message data file to identify a patient identifier of the patient.

13. The method of claim 12, wherein the message is a video including the audio portion.

14. The method of claim 12, further comprising receiving a message recipient identity through the network interface.

15. The method of claim 14, further comprising formatting a notification, wherein the notification includes at least a portion of the transcribed message data file and the patient identifier; and sending the notification to the message recipient through the transceiver.

16. The method of claim 12, further comprising providing an instruction to the user on format of a content of the message.

17. The method of claim 16, wherein the instruction is a series of separated question prompts.

18. The method of claim 12, wherein the transcription service is a Health Insurance Portability and Accountability Act compliant medical transcription service.

19. The method of claim 12, wherein the attachment includes any of a video file, an image file, or a document file.

20. Non-transitory computer-readable media with computer-executable instructions embodied thereon that when executed by a computing system perform a method of delivering a message having medical information about a patient, the computer-readable media comprising:
instructions for receiving an audio message data file through a network interface of the system, wherein the audio message data file includes medical information about the patient;
instructions for receiving a message recipient identity through the transceiver of the system;
instructions for storing the audio message data file and the message recipient identity in the memory;
instructions for transmitting the audio message data file for transcription through the transceiver of the system;
instructions for receiving a transcribed message data file corresponding to the audio message data file through the transceiver of the system;
instructions for storing the transcribed message data file in the memory;
instructions for analyzing the transcribed message data file to identify a last name of the patient;
instructions for formatting a first notification, wherein the first notification includes at least a portion of the transcribed message data file an identifier of the patient; and
instructions for sending the first notification to the message recipient through the transceiver.
